(19) United States
(12) Patent Application Publication
(10) Pub. No.: US 2011/0024538 A1
(43) Pub. Date: Feb. 3, 2011

(54) Combine Chopper For Feeding A Baler

(75) Inventors: Robert A. Matousek, Milan, IL (US); Patrick Kendrick, Hesston, KS (US)

Correspondence Address: AGCO Corporation, Legal Department, 4205 River Green Parkway, Duluth, GA, 30096, US

(73) Assignee: AGCO CORPORATION, Duluth, GA (US)

(21) Appl. No.: 12/645,084

(22) Filed: Dec. 22, 2009

Related U.S. Application Data
(60) Provisional application No. 61/230,381, filed on Jul. 31, 2009.

(51) Int. Cl. A01F 12/40; B02C 18/18

(52) U.S. Cl. 241/191; 241/195

(57) ABSTRACT

A chopper for a combine harvester for biomass collection. In one embodiment, crop material such as the residue or material other than grain (MOG) from the back of the combine is directly projected toward a target on a baler collection device. A tailboard with defection panels may be used to alter the direction of the crop residue from the combine. The tongue of the baler is configured to not obstruct the crop material as the crop material is projected toward the baler. One or more knives of a chopper coupled to the combine may be configured to optimally project MOG toward the baler. Also, the stuffer chute of the baler may be configured to facilitate the flow of crop material such as MOG and therefore minimize obstructions. The crop material is transferred from the combine to the baler without the use of a conveyor.

### CROSS REFERENCE TO RELATED APPLICATIONS

This application claims priority to co-pending U.S. provisional application No. 61/230,381 filed May 31, 2009, entitled “COMBINE HARVESTER AND BALER FOR BIOMASS COLLECTION”, which is entirely incorporated herein by reference. The present U.S. nonprovisional application is related to U.S. nonprovisional application entitled “BIOMASS BALER (A1038H)”, to U.S. nonprovisional application entitled “BALER TONGUE FOR COLLECTING BIOMASS (A1039H)”, to U.S. nonprovisional application entitled “BALER COLLECTOR FOR COLLECTING BIOMASS FROM A COMBINE HARVESTER (A1040H)”, to U.S. nonprovisional application entitled “BALER PICKUP FOR COLLECTING BIOMASS FROM A COMBINE HARVESTER (A1041H)”, to U.S. nonprovisional application entitled “BIOMASS DEFELCTOR (A1042H)”, to U.S. nonprovisional application entitled “METHOD FOR PROJECTING BIOMASS FROM A COMBINE HARVESTER (A1043H)”, to U.S. nonprovisional application entitled “BALER DENSITY CONTROL MECHANISM AND METHOD (A1045H)”, and to U.S. nonprovisional application entitled “USER INTERFACE WITH BIOMASS DEFELCTION INFORMATION (A1046H)”, which are incorporated herein by reference, and having been filed concurrently with the present application.

### TECHNICAL FIELD

The present disclosure relates generally to combine residue and collection for biomass fuel production.

### BACKGROUND

The combine harvester, or simply combine, has a history of development directed toward combining several operations into one complete machine. The combine completes these operations in one pass over a particular part of the field. Early combines were pulled through the fields by teams of horses or mules. Today, combines utilize GPS and auto-steering, but baling is typically performed as an additional step after the harvesting. After the combining operations are completed, a separate baler towed by a tractor is required to gather cut crops such as plant stalks from the field to form the plant stalks into round or square bales. Biomass fuels such as straw, hay or cereals may be pressed into bales to increase their energy density. The bales are subsequently picked up and trucked to where they are needed. What is needed is an improved means of combining the baling operation along with the operations of the combine harvester so that the crop may be harvested and the residue baled in a single pass of a combine harvester.

### BRIEF DESCRIPTION OF THE DRAWINGS

FIG. 1. is a partial side view of a combine harvester and a side view of a baler towed by the combine harvester;

FIG. 2 is a top view of the combine and towed baler of FIG. 1;

FIG. 3 is a bottom perspective view from the rear of the combine and towed baler of FIG. 1;

FIG. 4 is a partial top perspective view from the front of the frame and tongue of the towed baler with a transfer pan and a pickup;

FIG. 5 is a is partial top perspective view from the front of the frame of the towed baler without the transfer pan and pickup;

FIG. 6 is a close-up side view of the transfer pan;

FIG. 7 is a top view of the towed baler of FIG. 4 with the transfer pan and pickup;

FIG. 8 is a front view of the towed baler of FIG. 4 with the transfer pan and pickup;

FIG. 9 is a top perspective view from the front of the towed baler with a transfer pan according to an alternative embodiment;

FIG. 10 is a close-up view of the pickup of the baler in combination with a cutter;

FIG. 11 is a front perspective view of a packer and stuffer chute of the baler;

FIG. 12 is a top view of the baler and towed baler of FIG. 1 where the combine is turning;

FIG. 13 is a top perspective view from the rear of part of the tailboard in combination with the chopper of the combine;

FIG. 14 is a perspective view of the rotor of the chopper with lugs for receiving a plurality a dual knives;

FIG. 15 is a perspective view of a dual knife;

FIG. 16 is a perspective from of the dual knife of FIG. 31 from the opposite side;

FIG. 17 is a partial view of the chopper illustrating stationary knives passing between knife portions of the dual knife; and

FIG. 18 is a perspective view of a plurality of stationary knives in a retracted position relative the rotor with the dual knives.

### DESCRIPTION

The present invention will be described more fully hereinafter with reference to the accompanying drawings in which like numerals represent like elements throughout the several figures, and in which an exemplary embodiment of the invention is shown. This invention may, however, be embodied in many different forms and should not be construed as being limited to the embodiments set forth herein; rather, the embodiments are provided to make this disclosure thorough and complete, and to fully convey the scope of the invention to those skilled in the art. The present invention is described more fully hereinbelow.

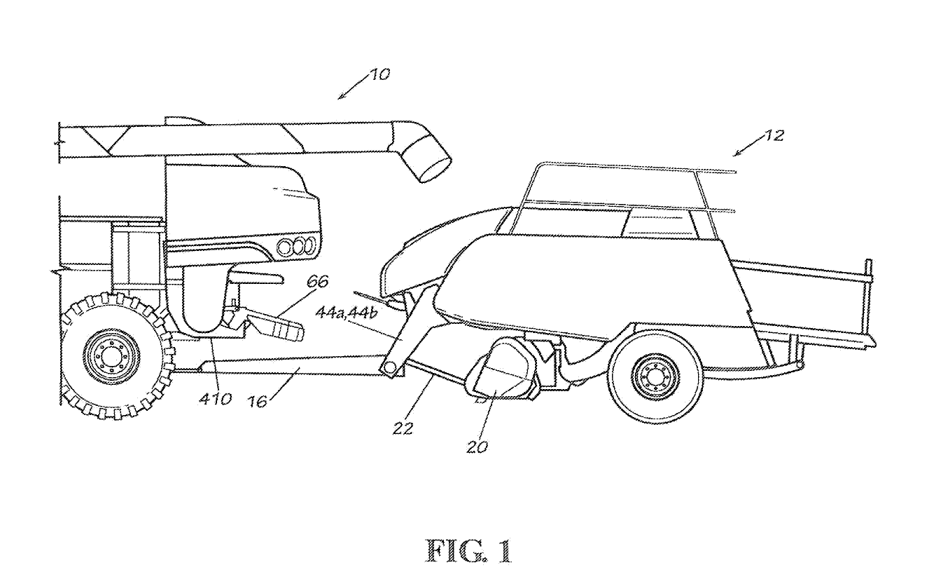

FIGS. 1-3 illustrate a combine 10 towing a baler 12 according to one embodiment of the present invention. The baler 12 is pivotally attached to the rear of the combine 10 via a tongue 16 which is coupled to the hitch point on the back of the combine 10. The baler 12 is preferably powered by a hydrostatic motor affixed to the flywheel of the baler 12 drawing its power source from the engine of the combine 10 via a hydrostatic pump.

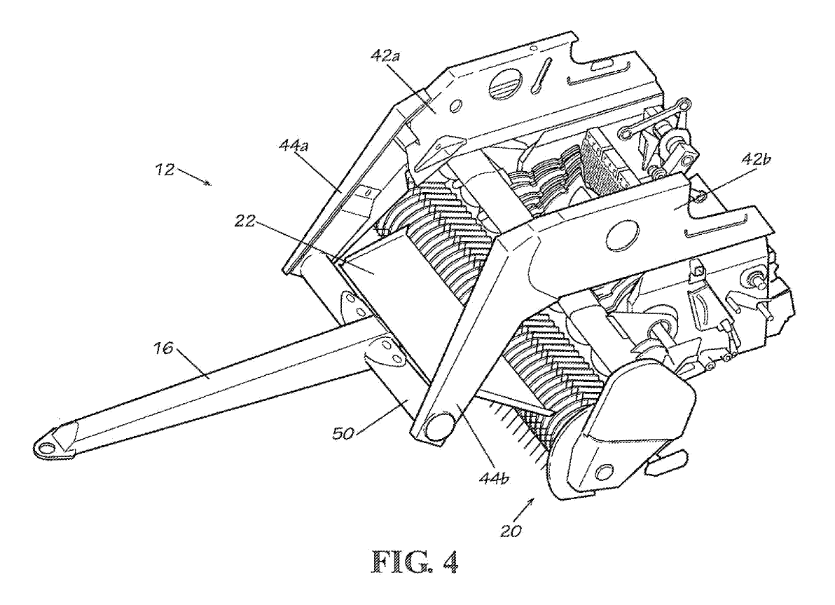

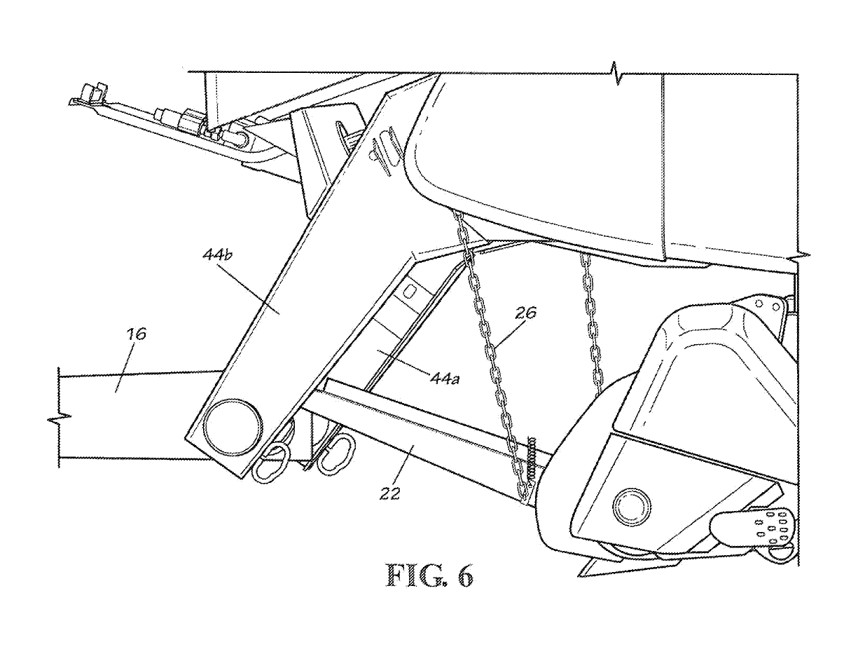

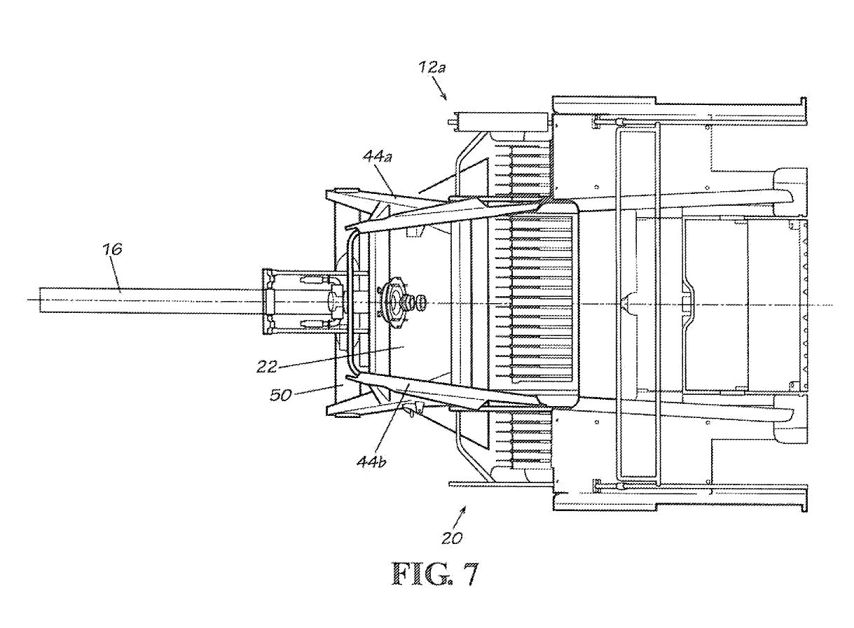

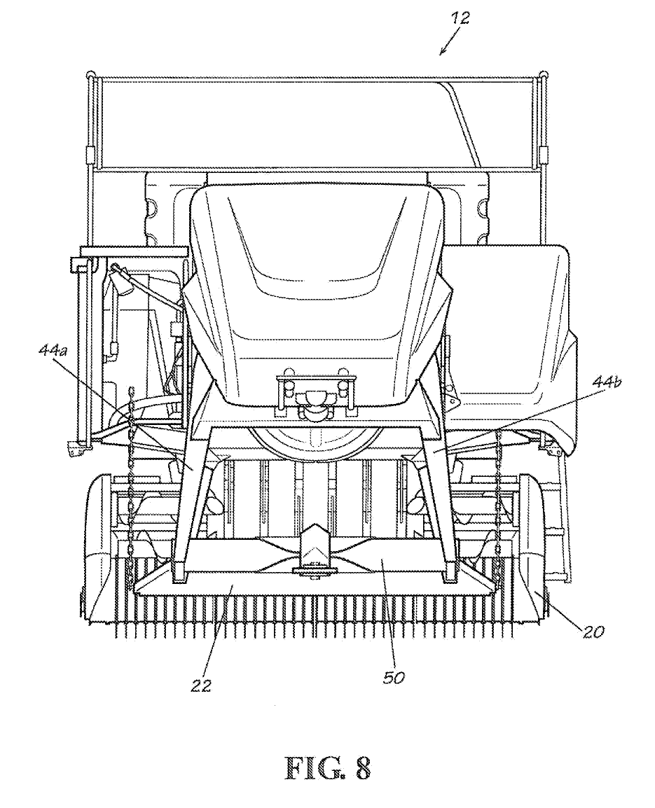

The tongue 16 is attached to the chassis or main frame of the baler 12. The chassis is made of steel frame construction. As best shown in FIGS. 4-9, the tongue 16 is configured to be coupled to the combine 10 so that when the crop material from the combine 10 can be transferred from the combine 10 directly to the baler 12 without redirection through the air by the combine and without the use of a conveyor coupled to either the combine 10 or the baler 12. The term “crop material” is intended to include grain and/or material other than grain (MOG), such as crop residue from the combine 10. Moreover, the tongue 16 and the chassis of the baler 12 are configured to the flow of crop material therethrough as described below. The crop material from the combine 10 preferably is directly discharged from the combine 10 to the baler 12. Also, the crop material from the combine 10 does not need to be oriented or moved upward from the back of the combine 10 in order to be transferred to the baler 12 or any other secondary vehicle according to an embodiment of the present invention.

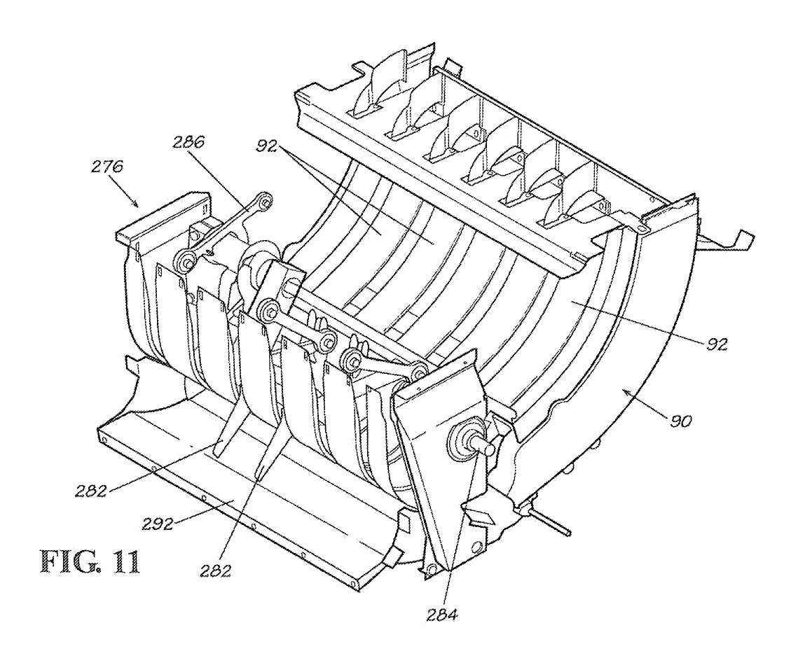

The crop material from the combine 10 is projected to a target defined by the baler 14. As best shown in FIGS. 4, 7, 8 and 10, the target may be a baler collection device or feeding mechanism such as a pickup 20, and/or a collector such as a transfer pan 22. Pickup 20 may be a rotating drum-type mechanism with flexible tines or teeth for lifting and conveying material from the ground to the baler 12. The pickup 20 may be mounted to the chassis of baler 12 for pivoting movement about an upwardly and rearwardly disposed transverse pivot axis. In one or more embodiments, at least a portion of crop material may be directly received from the combine 10 at the baler 12 without a pickup 20. As best shown in FIG. 11, at least a portion of the crop material may be directly discharged to a transfer pan 292 in front of the packer 276 which prevents crop material that is thrown to the packer from falling to the ground. Packing forks 282 can grab at least a portion of the crop material collected on the transfer pan 292 and move the crop material back to the stuffer chute 90.

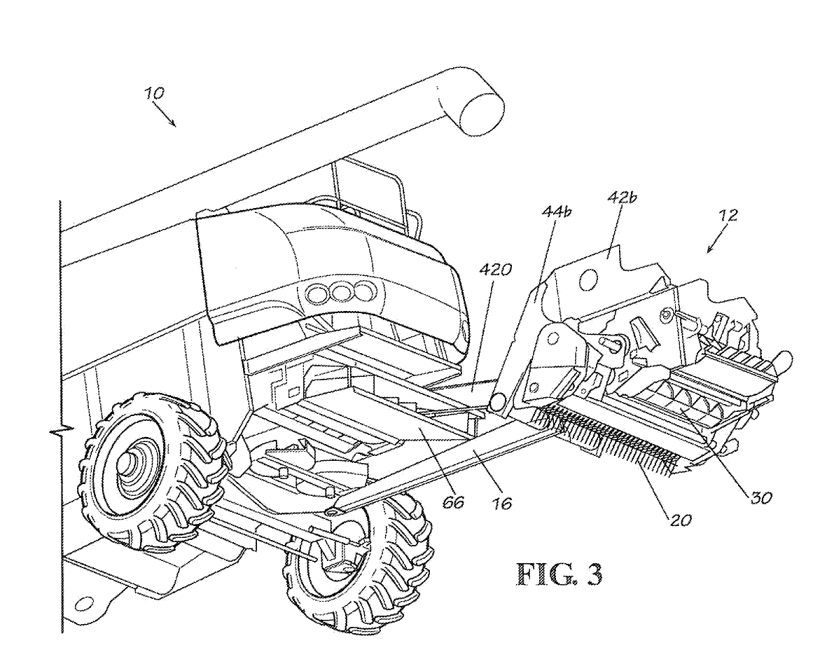

Also, if desired, crop material may also be lifted or received from the ground with the pickup 20. The pickup 20 may be either configured to receive material directly from the ground or directly from the combine 10. However, it is preferable not to mix crop material received directly from the combine 10 with crop material received from the ground because of the dirt and other contamination that occurs when crop material is on the ground. Introducing dirt into the bale can cause significant issues in a fuel conversion process. The crop material on the ground may be from the combine 10 towing the baler 12 or some other vehicle. A portion of crop material received directly from the combine 10 may be discharged from the same location on the combine 10 as any other portion of crop material discharged onto the ground to be picked up by the pickup 20 of the baler 12. However, in one or more embodiments, the combine 10 may have a chaff spreader as best shown in FIG. 3 where at least a portion of the chaff may be directed into the trajectory of the crop material coming out from the combine 10 and the tailboard 66. In another embodiment, the chaff can be directly discharged by the chaff spreader onto the baler 12. For example, the chaff may be received and collected on the transfer pan 22 for the pickup 20 or on the transfer pan 292 for the packer 276.

In one or more embodiments, air may be used to direct crop material collected on either of the transfer pans 22, 292 into the pickup 20 or just the packer 276 when the pickup 20 is not used. To much crop material on the transfer pans 22, 292 may become an obstruction and therefore could prevent additional crop material from being collected and baled as desired. The transfer pans 22, 292 may include one or more openings or apertures for passing pressurized air therethough at the collected crop material. Preferably, the pressurized air comes from the baler 12 itself by using a hydraulic motor that spins a fan such as the hydraulic driven fans known to be used on balers to keep knotters free of debris. The air may be passed through one or more passageways or tubes extending to the apertures in the surfaces of the transfer pans 22, 292. At least a portion of the transfer pans may be hollow. Preferably the apertures are configured to pass air upward from the surface of the transfer pans 22, 292 and backward at an angle toward the pickup 20 and/or packer 276. In another embodiment, the air could be directly blown at the crop material from the passageways or tubes. The direction of at least a portion of the air flow can be reoriented while the crop material is being collected. In another embodiment, at least a portion of the air flow can be used to clear the crop material from the transfer pans 22, 292 when the portion of crop material collected on the transfer pans is not to be picked up by the pickup 20 or to be packed by the packer 276. More example, a portion of the crop material may be stuck and obstructing other crop material from being received on the transfer pans 22, 292.

Preferably the transfer pan 22, 292 is coupled to the baler 10 in such a manner that the collected crop material is permitted to slide across the transfer pan. 22. Also, the transfer pan 22 may be permitted to bounce somewhat when impacted by the crop material or as a result of the baler 12 advancing along the ground behind the combine 10. The bouncing allows at least a portion of the crop material to impact the transfer pan 22, 292 and then convey or funnel at least a portion of the crop material toward the pickup 20 or toward the packer 276. Preferably, the transfer pan 22 directs the crop material onto the pickup 20. The transfer pan 22, 292 may be coupled to the baler by springs or chains 26, or a combination thereof. The shape and configuration of either of the transfer pans 22, 292 as well as the length of the chains 26 can be adjusted or the type of springs can be changed as needed to suit particular crops or conditions.

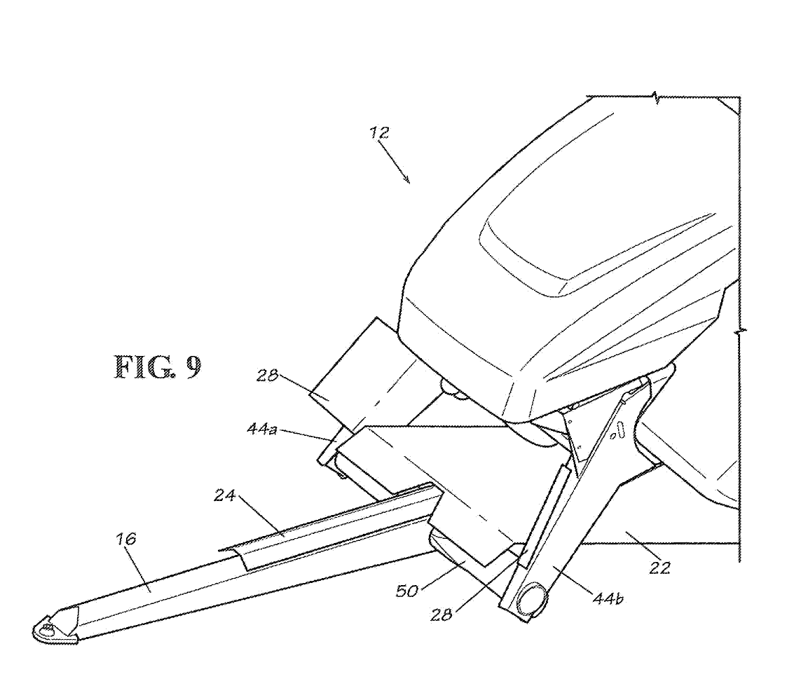

The transfer pans 22, 292 may also have an elongated portion 24, as best shown in FIG. 9, extending over the draw bar portion of the tongue 16 to protect electrical and/or hydraulic lines extending forward of the cross member 50 along the length of the tongue 16 from the impact of the crop material from the combine 10 intended for the baler 12. The electrical and hydraulic lines may run along the top of the tongue 16 or within the tongue 16 itself In either case, the elongated portion 24 shields the electrical and hydraulic lines. Thus, the elongated portion 24 is a protective member and not intended for receiving material. The elongated portion 24 may be an integral part of the transfer pans 22, 292 or may be a separate part extending from the remainder of the transfer pans 22, 292 intended for receiving material from the combine 10. The elongated portion may extend almost the entire length of the tongue 16 or only a portion thereof.

Also, as shown in FIG. 9, one or more deflector panels 28 coupled to the baler 12 can be utilized to deflect the crop material from the combine 10 inward to the transfer pans 22, 292. The deflector panels 28 may be fastened to either side of the forward frame members 44a, 44b but are preferably fastened to the inside of the forward frame members 44a, 44b and extend in a forward manner from the forward frame members 44a, 44b. The deflector panels 28 may have a length generally corresponding with the length of the forward frame members 44a, 44b extending above the transfer pans 22, 292. Each of the deflector panels 28 may have two portions angled relative to one another where outer portions of the deflector panels 28 extend outward from the forward members 44a, 44b, and the inner portions are fastened to the side of the forward frame members 44a, 44b.

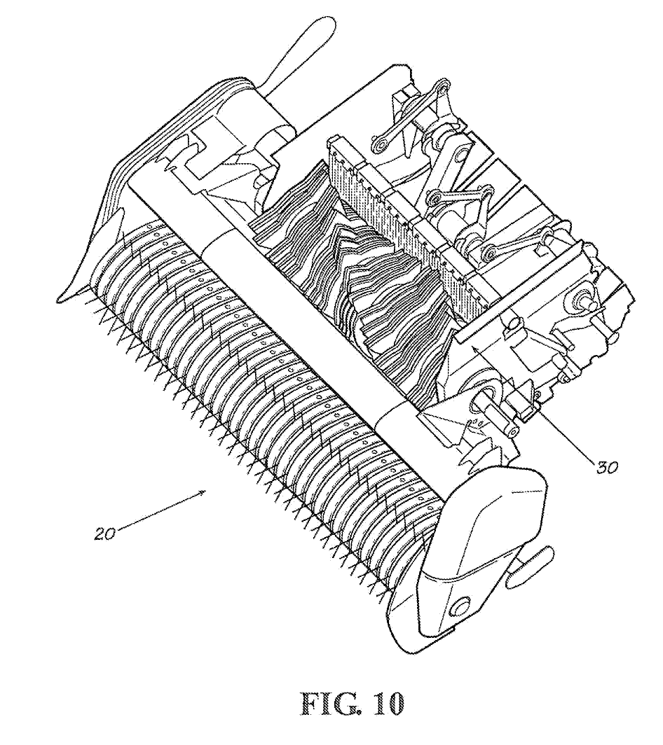

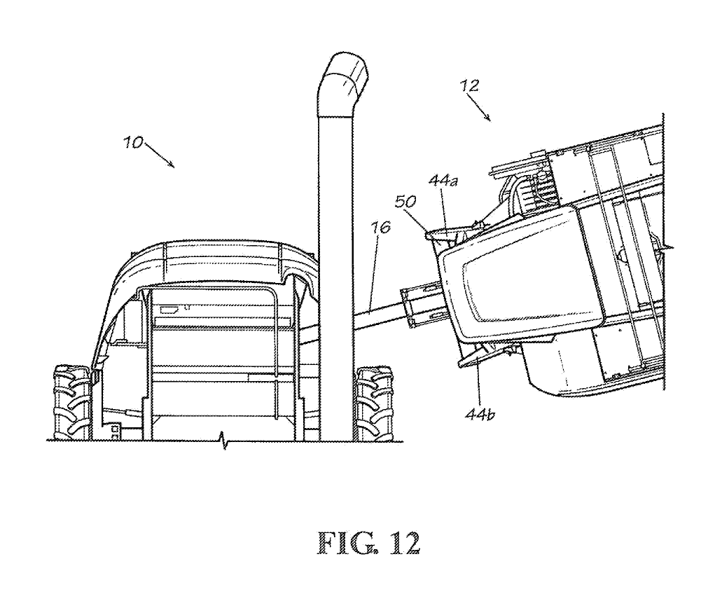

As best shown in FIGS. 3 and 10, the baler 12 may include a cutter 30 positioned after the pickup 20 and before the packer 276 to reduce the distance the crop material must travel from the combine 10 before it is baled. As a result of using a cutter 30 in between the pickup 20 and the packer 36, the pickup 20 is moved forward toward the tongue 16, compared with when using just a pickup 20 on conventional balers, so that the distance between the back of the combine 10 and the target on the bailer 12 is reduced. By positioning the cutter 30 in between the pickup 20 and the packer 36, the pickup 20 and transfer pan 22 may be moved forward approximately eighteen inches or more. Alternatively, the length of some tongues 16 may be adjusted mechanically to obtain the desired distance between the back of the combine 10 and the baler 12. FIG. 12 shows the combine 10 turning but the length and shape of the tongue 16 is sufficient to preclude the tongue 16 or baler 12 from impacting the combine 10.

In another embodiment, the baler 12 may include a rotary feeding mechanism rather than the cutter 30. A rotary feeder is distinguishable from the cutter 30 in that the blades are different and that on some occasions it is not desirable to cut the crop material any further than it already has been. On such occasions though it may be desirable to merely feed the crop material with the rotary feeder into the packer 276.

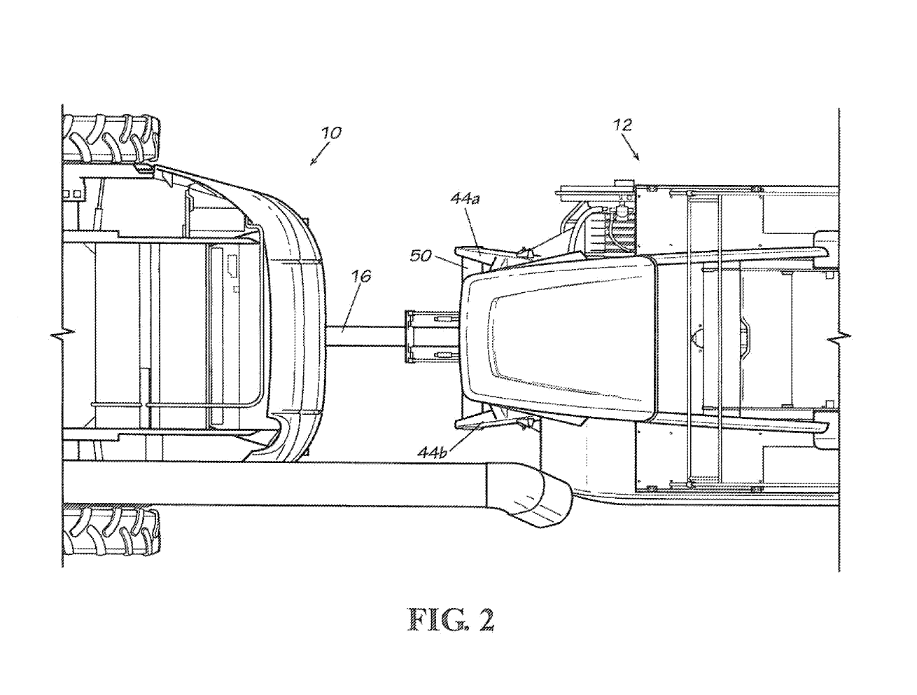

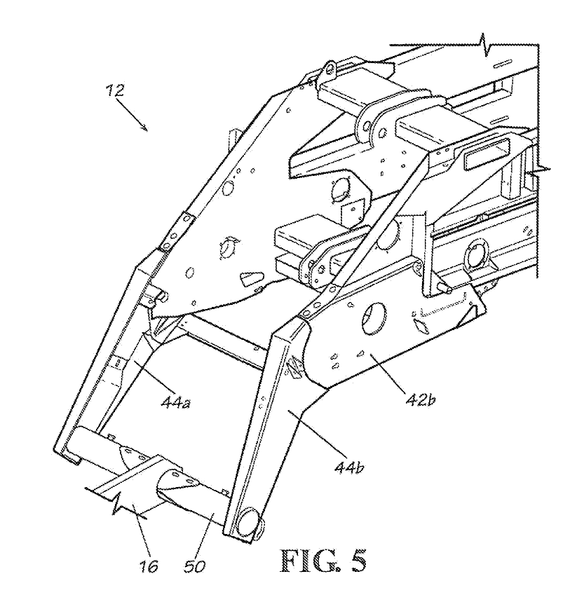

FIGS. 4 and 5 best depict a cutaway of a portion of the baler 12. Side frame portions 42a, 42b are similar to those used on conventional balers with conventional tongues adapted to be towed behind tractors. However, the main frame of baler 12 is modified from those of conventional balers because the baler 12 includes two forward frame members 44a, 44b. Each of the forward frame members 44a, 44b is connected at its upper end to an end of one of the side frame portions 42a, 44b and extends downward from the main frame. The lower ends of the two forward frame members 44a, 44b are preferably oriented slightly forward of the pickup 20 and in front of the point to which they attach to the side frame portions 42a, 42b. Moreover, the lower ends may be flared outwardly relative to one another, as best shown in FIGS. 2, 7 and 8, with a cross member 50 connected in between each lower end of the forward frame members 44a,44b. The cross member 50 and the draw bar portion of the tongue 16 define generally a T-shaped tongue which is distinguishable from common U-shaped tongues in use today with conventional balers. The forward frame members 44a, 44b are oriented alongside one another to define an opening therebetween and above the cross member 50. Because the lower ends of the forward frame members 44a, 44bb are flared outwardly, the opening is wider at its bottom adjacent the cross member 50 than the opening is at its top adjacent to where the forward frame members 44a, 44b join side frame portions 42a, 42b. Moreover, the configuration of the tongue 16 allows for greater visibility into the pickup 20 of the baler 12. The tongue 16 also permits flow of crop material directly from the ground as conventional balers do or directly from the combine 10 without either being obstructed by the tongue 16.

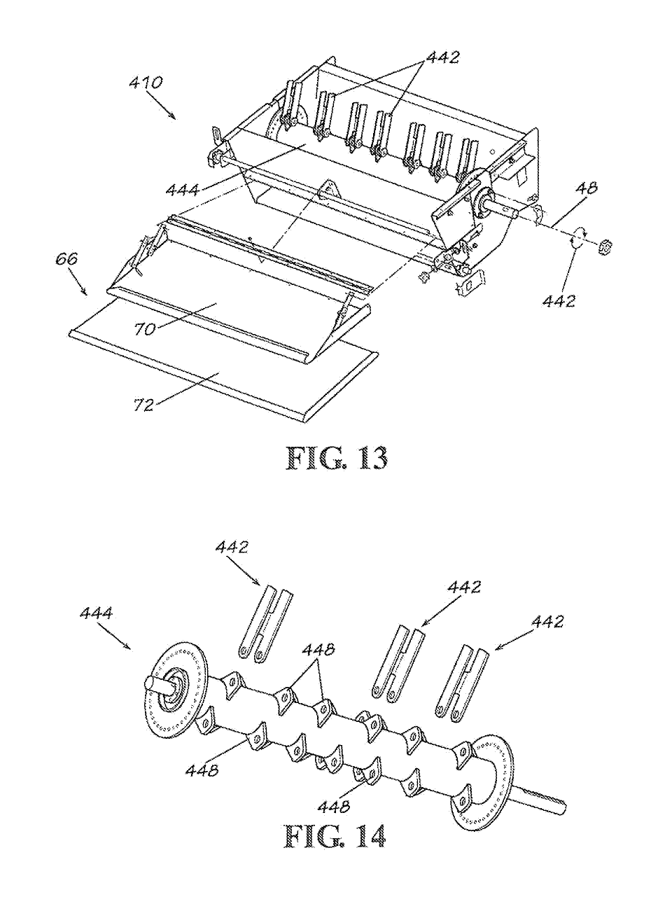

Referring to FIGS. 13-18, the combine 10 may include a chopper 410. The chopper 410 preferably is a crop residue or MOG chopper for receiving straw and other residue from the combine 10, and propelling or projecting it outward from the combine 10 as denoted by the trajectory path 420 by rotation of the chopper 410 as denoted by the rotation arrow 422. Chopper 410 is distinguishable from conventional choppers because chopper 410 includes one or more dual knifes 442 as described in detail below.

As best shown in FIGS. 13 and 14, the chopper 410 includes an elongated cylindrical rotor 444 supported within a housing of combine 10 for rotation in a predetermined rotational direction about a rotational axis extending longitudinally through rotor 444. Rotor 444 is supported for rotation by bushings, bearings, or the like, and is rotatable using a suitable rotatable power source, including, but not limited to, a belt or drive shaft connected to an engine of the combine 10, a hydraulic motor or the like. Rotor 444 includes an outer cylindrical surface having a plurality of brackets of mounting lugs 448 mounted thereon in preferably in two diametrically opposed helical arrays where each array extends the length of the rotor 444.

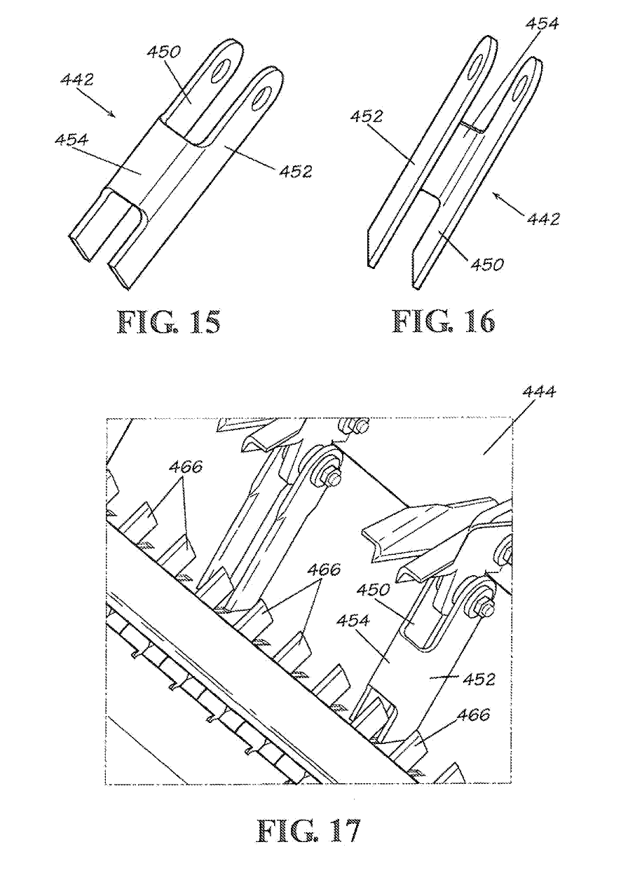

As best shown in FIGS. 15 and 16, each dual knife 442 includes first and second knife portions 450, 452 with a web portion 454 in between each set of first and second knife portions 450, 452 connecting the first and second knife portions 450, 452 together. The sides of corresponding first and second knife portions 450, 452 are preferably parallel to one another. Each dual knife 442 is preferably made of sheet metal, blanked and formed into generally a U-shape. The dual knives 442 are preferably of a thickness greater than conventional knives because the dual knives 442 serve a dual purpose. The sheet metal may be at approximately ⅛ inches thick or greater with the edges of the knife portions 450, 452 not sharpened. The dual knives 442 may not only cut or chop the residue or MOG but the dual knives 442 may also impact MOG to eject the MOG from the chopper 410 and the combine 10 and then project the MOG to the baler 12. One or more dual knives 442 may be used in combination with other conventional knives within the same chopper 410 depending on the crop and crop conditions as shown in FIG. 17. The dual knives 442 may be used with many types of crops and materials such as corn cobs, soy bean and the like, and therefore, for example, the dual knives do not need to be changed between corn and soy beans.

Each knife portion 450, 452 has a proximal end or mounting end with an aperture therethrough for mounting the dual knifes 442 to the rotor 444 such that the dual knives 442 may be pivotally mounted to the rotor 444 in a spaced relationship to one another. Preferably, a lug 448 is received between a corresponding pair of knife portions 450, 452 of a dual knife 442 and mounted so that the dual knife 442 is free to swing as the rotor 444 rotates. Each knife portion 450, 452 also includes a distal end or free end. The web portion 454 preferably extends between a corresponding pair of knife portions 450, 452 and joins the corresponding pair of knife portions 450, 452 along bends which extend only partially along the lengths of an edge of each corresponding knife portion 450, 452. Preferably, the web portion 454 extends short of the proximal and distal ends of each corresponding knife portion 450, 452. The web portion 454 prevents the knife portions 450, 452 from deflecting, twisting, or tilting along their lengths from their mounting point with the lugs 448 on the rotor 444 as a result of impacting MOG such as corn cobs. The web portion 454 also creates air resistance and movement within the chopper 410 to facilitate conditioning of the material through the chopper 410.

The chopper 410 with one or more dual knives 442 may be operated at conventional speeds. However, the chopper 410 may also be run at reduced speeds in the range of approximately 700-1,100 rotations per minute, and preferably in a range of about 800-900 rotations per minute when lower speeds are desired based on the material and conditions, so that MOG such as corn cobs may be projected or paddled directly to the baler 12. The swinging dual knives 442 do not increase wear on the chopper 410 because the dual knives 442 are more robust than conventional knives. Also, the web portion 454, not only protects the knife portions 450, 452, but allows the chopper 410 to operate at lower rotations per minute and still attain the desired conditioning of the material as well as the desired velocity and trajectory when the MOG is projected toward the baler 12.

However, the chopper 410 may also be operated at a range of 1500-1600 rotations per minute and still project MOG such as corn cobs to the baler 12, brake or chop the corn cobs to attain the desired bale density, or still chop other materials such as soy beans. Therefore, over a wide range of operating speeds, the chopper 410 with one or more dual blades 442 optimally chops and discharges MOG to provide the desired conditioning to the many types of MOG as well as, when desired, provide the proper velocity and trajectory to the MOG to be received at the baler 12.

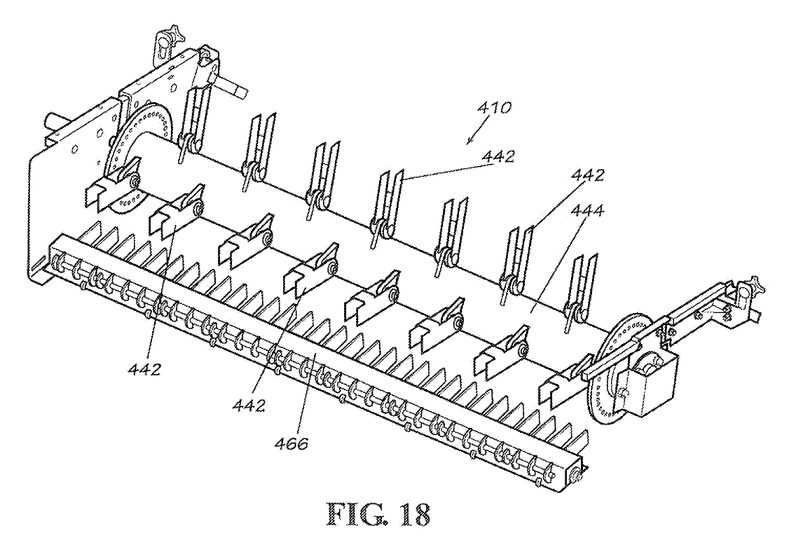

One or more dual knifes 442 and their corresponding knife portions 450, 452 cooperate with a plurality of stationary knives 466. The stationary knives 466 may be moved between a retracted position, as shown in FIG. 18, and an engaged position relative the dual knives 442 on the rotor 444. In the engaged position, as best shown in FIG. 17, a distal end of a stationary knife 466 passes in between the corresponding knife portions 450, 452 of a dual knife 442, without impacting the web portion 454 in order to provide at least a portion of chopped or cut MOG which will be projected toward the baler 12.

The foregoing has broadly outlined some of the more pertinent aspects and features of the present invention. These should be construed to be merely illustrative of some of the more prominent features and applications of the invention. Other beneficial results can be obtained by applying the disclosed information in a different manner or by modifying the disclosed embodiments. Accordingly, other aspects and a more comprehensive understanding of the invention may be obtained by referring to the detailed description of the exemplary embodiments taken in conjunction with the accompanying drawings, in addition to the scope of the invention defined by the claims.

What is claimed is:

1. A chopper comprising:
a rotor having a plurality of mounting lugs; and
at least one dual knife, said dual knife mounted to a lug and have corresponding knife portions connected by a web portion therebetween.

2. The chopper of claim 1 wherein each said web portion extends from an edge of each of said corresponding knife portions.

3. The chopper of claim 1 wherein each said web extends along a length of each said knife portion short of a distal end of each said corresponding knife portion.

4. The chopper of claim 1 wherein said dual knife swings from said lug when said rotor is rotating and each corresponding knife portions of said dual knife remain substantially parallel to one another as said rotor rotates.

5. The chopper of claim 1 wherein said dual knife is configured to chop a portion of MOG as well as impact said MOG to project said MOG with sufficient velocity and trajectory toward a baler.

6. The chopper of claim 1 further comprising one or more knives other than said dual knife mounted to said rotor.

7. The chopper of claim 1 wherein said knife portions of a dual knife are spaced from one another to permit another knife to pass therebetween without said other knife impacting said web portion of said dual knife when said rotor is rotating.

8. The chopper of claim 1 wherein the rotation of said rotor is adjusted to affect the trajectory of MOG impacted by said dual knife to a baler.

9. The chopper of claim 1 wherein the rotation of said rotor is adjusted to affect the velocity of MOG impacted by said dual knife to a baler.

10. A dual knife for a chopper coupled to a combine harvester, comprising:
a corresponding pair of knife portions parallel aligned to one another and configured to be mounted to a rotor of said chopper; and
a web portion connecting said knife portions to one another to maintain said knife portions in alignment with one another.

11. The dual knife of claim 10 wherein said web portion extends from a midpoint along each of said knife portions and short of distal ends of said knife portions.

12. The dual knife of claim 10 wherein said web portion extends from an edge of said knife portions.

13. The dual knife of claim 10 wherein said web portion is defined between bends in said dual knife.

14. The dual knife of claim 10 formed from a blank bent into generally a U-shape.

15. The dual knife of claim 10 wherein said knife portions are spaced apart to receive and cooperate with another knife therebetween as said rotor of said chopper rotates.
